(19) United States
(12) Patent Application Publication
(10) Pub. No.: US 2006/0248160 A1
(43) Pub. Date: Nov. 2, 2006

(54) Facilitation of online discussion

(76) Inventor: David William Plummer, Redmond, WA (US)

Correspondence Address: BLACK LOWE & GRAHAM, PLLC, 701 FIFTH AVENUE, SUITE 4800, SEATTLE, WA, 98104, US

(21) Appl. No.: 11/351,257

(22) Filed: Feb. 9, 2006

Related U.S. Application Data
(60) Provisional application No. 60/651,953, filed on Feb. 9, 2005.
(60) Provisional application No. 60/727,288, filed on Oct. 14, 2005.

(51) Int. Cl. G06F 15/16

(52) U.S. Cl. 709/217

(57) ABSTRACT

A method includes receiving, at a first network address and from a first client device of a plurality of client devices, an identifier of a second network address. In response to receiving the identifier from the first client device, first content corresponding to the second network address is provided to the first client device. Second content from the first client device is received at the first network address. The identifier is received at the first network address and from a second client device of the plurality of client devices. In response to receiving the identifier from the second client device, the second content is provided to the second client device.

### PRIORITY CLAIM

The present application claims priority from U.S. Provisional Application No. 60/651,953 filed Feb. 9, 2005, and from U.S. Provisional Application No. 60/727,288 filed Oct. 14, 2005, each of which is herein incorporated by reference.

### FIELD OF THE INVENTION

An embodiment of the invention relates generally to Internet communication and, more specifically, to providing online-discussion forums.

### BACKGROUND OF THE INVENTION

The Internet exists as a collection of millions of interconnected, independently operated computer systems. Individuals, companies, and other organizations have become accustomed to harnessing the power of the Internet to present information to others and engage in e-commerce by maintaining passive and interactive web sites. To create a web site, a software application called a web server is installed on an Internet-connected computer and web pages are placed therein.

A remote user is able to access web pages in a particular web server by pointing an Internet browser to the URL that points to the IP address of the web server. Often, this is accomplished by entering the web site URL into an address bar of the browser. In this manner, a user can be in one location and access web sites and information located in various geographic areas of the world. Similarly, other users can be in other physical locations and access the same or different information. Accordingly, web sites receive many requests for information from various physically separated individuals. Many web sites have thousands of visitors either simultaneously or over the course of time. Therefore, there are often very large numbers of physically separated individuals who share a common interest in the information provided by a particular web site.

The value in communicating with other individuals with common interests is obvious. In the physical world, people join organized entities such as clubs and sports teams to share experiences and learn from each other. Similarly, people loosely associate in non-organized entities in coffee shops, restaurants, and bars. Even online, the value of communicating with others who share similar interests has manifested itself through the use of chat rooms, forums, weblogs (“blogs”) and instant messaging (collectively, “message forums”).

Chat rooms are virtual meeting spaces that allow for simultaneous communications between multiple people. These virtual spaces are analogous to coffee shops or bars whereby anyone in the space can talk with any other person within the space. Generally, chat rooms are organized around a topic so that the people who enter the virtual space have a common interest. For instance, there are chat rooms for politics, sports, dating, and cars. To enter a chat room, a user must visit an independent web site and search for different chat rooms to join.

Forums are similar to chat rooms in that they allow online communication between multiple users. However, forums are significantly different from chat rooms in that forums allow for communication over time between other users. A chat room requires simultaneous participation between other users. A forum allows a first user to post a message and subsequent users to read that message at times when the first user is no longer online. Forums are arranged around topic areas such as programming languages, health, cars, and education. A user must visit an independent web site to search for various forums to enter.

A blog may be considered as a personal or corporate web site in which an author writes, as their consideration of a given subject evolves, their opinions, impressions, etc., so as to make them public and receive reactions and comments about them.

Instant messaging is Internet communication between users. It is similar to chat rooms in that it requires simultaneous communication between online users. However, it is different from chat rooms in that it involves communication between two individuals. In this way, instant messaging is more analogous to phone conversations. To communicate with another user using a chat program it is necessary to know the username of the user and for that user to be simultaneously online.

Chat rooms, forums, blogs and instant messaging are strong indicators of the benefits of online communications that revolve around common interests. Therefore, when thousands of individuals visit a web site simultaneously or over time, it would be extremely useful for those individuals to have the ability to easily communicate with each other. However, the existing Internet communication technologies standing alone are unsuitable to address this issue. This invention addresses this and many other problems.

### BRIEF DESCRIPTION OF THE DRAWINGS

Preferred and alternative embodiments of the present invention are described in detail below with reference to the following drawings:

FIG. 1 is a schematic view of an exemplary operating environment in which an embodiment of the invention can be implemented;

FIG. 2 is a functional block diagram of an exemplary operating environment in which an embodiment of the invention can be implemented;

FIG. 3 is a schematic view of a graphical user interface (GUI) according to an embodiment of the invention;

FIG. 4 is an enlarged illustration of a GUI according to an embodiment of the invention;

FIG. 5 is an enlarged illustration of a GUI toolbar according to an embodiment of the invention;

FIG. 6 is a flow diagram illustrating a method according to an embodiment of the invention; and

FIG. 7 is a flow diagram illustrating a method according to an embodiment of the invention.

### DETAILED DESCRIPTION OF THE PREFERRED EMBODIMENT

An embodiment of the invention is directed to a method for allowing users to participate in message forums at any web site by using an Internet browser to access and display content from a web site; transmitting the web site URL to one or more servers and/or centralized databases employing one or more domain identifiers; retrieving information from the database that is associated with the URL; and displaying the information adjacent to and contemporaneously with the content from the web site.

In one embodiment, a Message Client is installed and deployed on a client computer whereby the Message-Client GUI is displayed within a browser. For example, the GUI may be displayed within a browser window as a horizontal browser band docked at the bottom of the window. However, the GUI may be displayed in other browsers, in alternative positions, or independently of a browser. To enable the Message Client functionality, the user may authenticate himself or herself by using a username and password or other form of authentication. The Message Client automatically obtains the browser's current URL and username and transmits this information over the Internet to a remote server. Alternatively, the URL may be obtained manually. The remote server accepts the URL and optional username, optionally saves the information for reference, and retrieves information associated with the URL in the server database. The URL associated information is transmitted back to the requesting Message Client and displayed in the GUI adjacent to and contemporaneously with the web site content. This information may include, but is not limited, to usernames, user information, forum names, forum messages, dates, and times. This information is received and processed by the Message Client whereby useful information is organized, formatted, and displayed in the GUI. The user may, among other things, filter, read, search, sort, move, save, print, rate users, rate forums, block users, group, pin, and organize this information. In addition, the client enables the user to communicate with other individuals by means of message forums, message boards, blogs, emails, chat rooms, or instant messaging. However, other forms of communication could also be used, like voice or symbolic communication. These communications are archived in association with corresponding web content and/or a forum, that may or may not be associated with web content, within the central server for reference by all users.

In another embodiment, the GUI may be minimized or maximized.

In yet another embodiment, the GUI buttons may be dynamically disabled and enabled depending on whether the underlying function is supported in the given context.

In an additional embodiment, the GUI menu bars may be expanded and retracted to conserve screen space.

In another embodiment, the GUI offers the user suggestions of other web sites or forums that may be of interest.

In yet another embodiment, the GUI sub-windows have scroll features to conserve screen space.

In another embodiment, hierarchical GUI menus are expandable or retractable.

In yet another embodiment, GUI sub-windows have panes that are individually resizable to conserve screen space.

In another embodiment, display information is segregated into pages whereby the user can navigate individual pages to conserve screen space.

In a further embodiment, the GUI allows the user to create, manage, or remove folders for retaining and bookmarking information relating to favorite messages, users, or forums.

In a further embodiment, advertisements are displayed in a GUI sub-window.

In a further embodiment, the user can manage account options from the GUI.

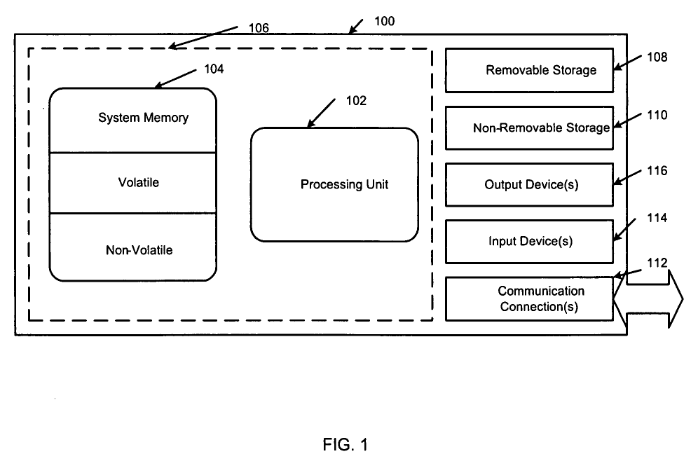

FIG. 1 illustrates an example of a suitable computing system environment 100 on which an embodiment of the invention may be implemented. The computing system environment 100 is only one example of a suitable computing environment and is not intended to suggest any limitation as to the scope of use or functionality of embodiments of the invention. Neither should the computing environment 100 be interpreted as having any dependency or requirement relating to any one or combination of components illustrated in the exemplary operating environment 100.

Embodiments of the invention are operational with numerous other general-purpose or special-purpose computing-system environments or configurations. Examples of well-known computing systems, environments, and/or configurations that may be suitable for use with embodiments of the invention include, but are not limited to, personal computers, server computers, hand-held or laptop devices, multiprocessor systems, microprocessor-based systems, set-top boxes, programmable consumer electronics, network PCs, minicomputers, mainframe computers, mobile devices, such as cell phones, distributed-computing environments that include any of the above systems or devices, and the like.

Embodiments of the invention may be described in the general context of computer-executable instructions, such as program modules, being executed by a computer. Generally, program modules include routines, programs, objects, components, data structures, etc. that perform particular tasks or implement particular abstract data types. Embodiments of the invention may also be practiced in distributed-computing environments where tasks are performed by remote processing devices that are linked through a communications network. In a distributed-computing environment, program modules may be located in both local- and remote-computer storage media including memory storage devices.

With reference to FIG. 1, an exemplary system for implementing an embodiment of the invention includes a computing device, such as computing device 100. In its most basic configuration, computing device 100 typically includes at least one processing unit 102 and memory 104.

Depending on the exact configuration and type of computing device, memory 104 may be volatile (such as random-access memory (RAM)), non-volatile (such as read-only memory (ROM), flash memory, etc.) or some combination of the two. This most basic configuration is illustrated in FIG. 1 by dashed line 106.

Additionally, device 100 may have additional features/functionality. For example, device 100 may also include additional storage (removable and/or non-removable) including, but not limited to, magnetic or optical disks or tape. Such additional storage is illustrated in FIG. 1 by removable storage 108 and non-removable storage 110. Computer storage media includes volatile and nonvolatile, removable and non-removable media implemented in any method or technology for storage of information such as computer-readable instructions, data structures, program modules or other data. Memory 104, removable storage 108 and non-removable storage 110 are all examples of computer storage media. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by device 100. Any such computer storage media may be part of device 100.

Device 100 may also contain communications connection(s) 112 that allow the device to communicate with other devices. Communications connection(s) 112 is an example of communication media. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio-frequency (RF), infrared and other wireless media. The term computer-readable media as used herein includes both storage media and communication media.

Device 100 may also have input device(s) 114 such as keyboard, mouse, pen, voice-input device, touch-input device, etc. Output device(s) 116 such as a display, speakers, printer, etc. may also be included. All such devices are well-known in the art and need not be discussed at length here.

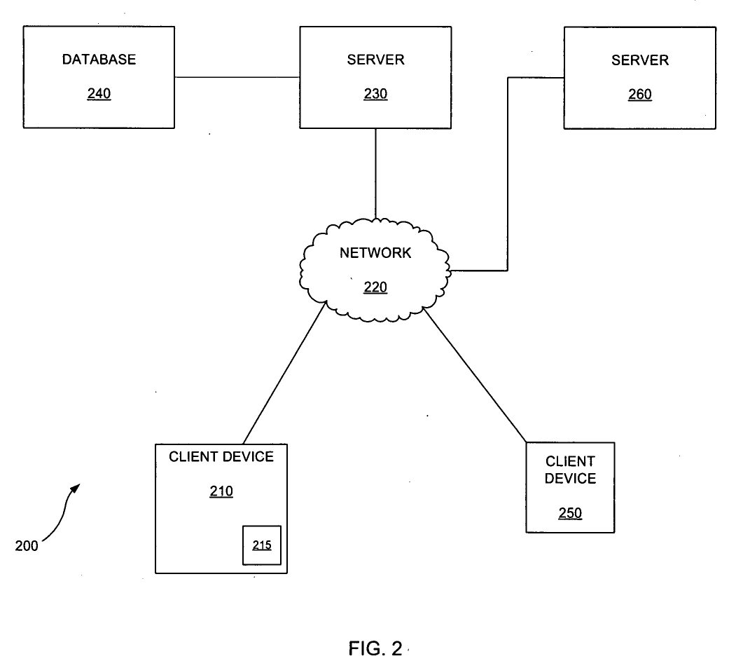

Referring now to FIG. 2, an embodiment of the present invention can be described in the context of an exemplary computer network system 200 as illustrated. System 200 includes an electronic client device 210, such as a personal computer or workstation, that is linked via a communication medium, such as a network 220 (e.g., two or more computer systems in communication with one another, such as the Internet), to an electronic device or system, such as a server 230 having a first network address. The server 230 may further be coupled, or otherwise have access, to a memory device, such as a database 240. The system 200 may further include an additional client device 250 and server 260, which has a second network address, coupled to the network 220. Although the embodiment illustrated in FIG. 2 includes one or more servers 230, 260 coupled to one or more client devices 210, 250 via the network 220, it should be recognized that embodiments of the invention may be implemented using more or fewer such client devices coupled to more or fewer such servers.

In an embodiment, each of the client devices 210, 250 and servers 230, 260 may include all or fewer than all of the features associated with the device 100 illustrated in and discussed with reference to FIG. 1. Client devices 210, 250 may include or otherwise be coupled to a computer screen or other conventional display device (not shown). Client devices 210, 250 can be used for various purposes including both network- and local-computing processes.

The client devices 210, 250 are linked via the network 220 to servers 230, 260 so that computer programs, such as, for example, a browser, running on one or more of the client devices 210, 250 can cooperate in two-way communication with servers 230, 260. Server 230 may be coupled to database 240 to retrieve information therefrom and to store information thereto. Database 240 may include a plurality of different tables (not shown) that can be used by server 230 to enable performance of various aspects of embodiments of the invention.

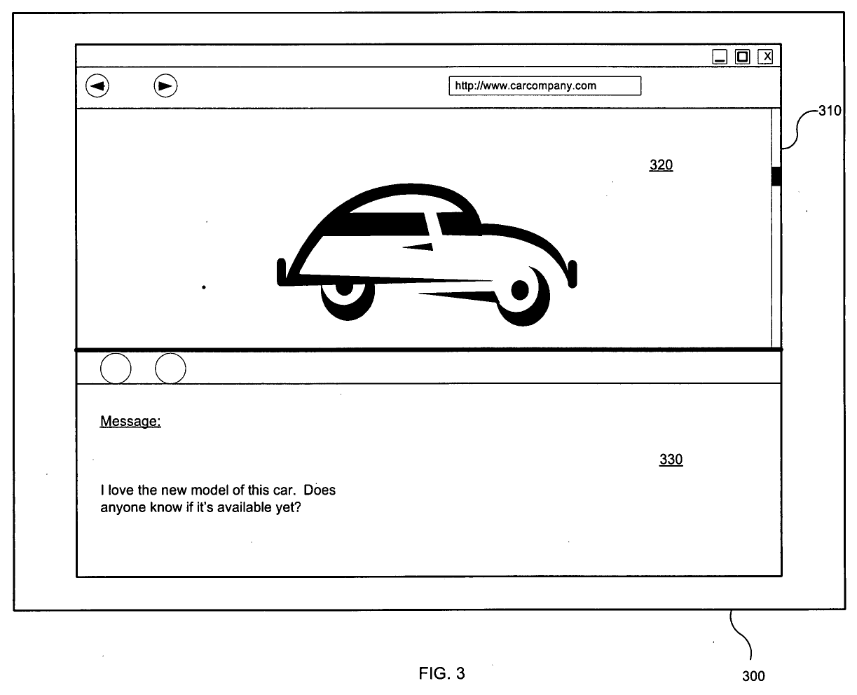

In operation, according to an embodiment of the invention, a user of the client device 210 may download from the server 230, or otherwise conventionally obtain, computer-executable instructions that, when installed and executed by the client device 210, provide a message-forum client application 215 that includes GUI 330 displayable on a display screen 300 (FIG. 3) coupled to the client device 210. In an embodiment, the GUI 330 includes a browser or other graphical-interface application that allows a user of the client device 210 to navigate or otherwise interact with content (e.g., web pages) received over the network 220.

Referring to FIG. 3, a user of the client device 210 wishing to participate in a forum pertaining to a particular web site can prompt the client device to display on the screen 300 a browser window 310. By pointing the browser to the network location of the desired web site (e.g., a URL or other address indicator associated with, for example, the server 260), a web page 320 associated with the web site may be displayed within the window 310.

Upon, or prior to, display of the web page 320, the GUI 330 may be displayed on the screen 300. As illustrated in FIG. 3, the GUI 330 may be configured to occupy a portion of the window 310 within which the web page 320 is displayed. Alternatively, the GUI 330 is displayed in a window (not shown) different from the window 310 within which the web page 320 is displayed.

In an embodiment, the client application 215, upon the user's selection of the web page 320, prompts the client device 210 to provide to the server 230 an identifier (e.g., URL, IP address, domain name, etc.) of the network location of the selected web page. Additionally, to enable message-forum functionality, the user of the client device 210 may identify himself by providing to the server 230 a username/password combination or other conventional form of authentication.

In an embodiment, upon receipt of the address identifier, the server 230 queries the database 240 for message-forum information associated in the database with the identifier and/or web page 320. Alternatively, the server 230 may query a memory device internal to the server 230 for such message-forum information. This information may include, for example, comments pertaining to the web page 320 and previously posted to the server 230 over the network 220 by the user of the client device 210 and/or a user of, for example, the client device 250. This information may further include usernames, user information, forum names, forum messages, dates, times, and/or any other conventional information associated with online forums. If no such information is present in the database 240, the server 230 may issue a message to the client device 210 informing the user that no comments or other content pertaining to the web page 320 has been posted to the server 230.

Such associated information present in the database 240 (or other queried memory) is provided by the server 230 to the client application 215 and displayed in, or otherwise used to populate, the GUI 330. The user may, for example, filter, read, search, sort, move, save, print, rate users, rate forums, block users, group, pin, and organize this information. In addition, the client application 215, via the GUI 330, enables the user to post to the server 230 comments or other content pertaining to the web page 320 and/or forums that may or may not be associated with a web page. The server 230 may store the posted content in the database 240 in such manner as to associate the posted content with the web page 320 and/or corresponding network-location identifier. In an embodiment, the client application 215, via the GUI 330, enables the user to control the format and editorial permissions with respect to information posted by the user to the server 230. For example, the user may in this manner create a blog to which only the user may post comments. Alternatively, the user may create a “closed community” message board to which only the user and, for example, people to whom the user provides a password may post comments.

In an embodiment, each time the browser associated with window 310 is pointed to a network address (e.g., when the user transitions from one web page or site to another), the client application 215 automatically populates the GUI 330 with any information corresponding to the network address and present in the database 240. Alternatively, the client application will attempt to populate the GUI 330 only in response to manual prompting by the user.

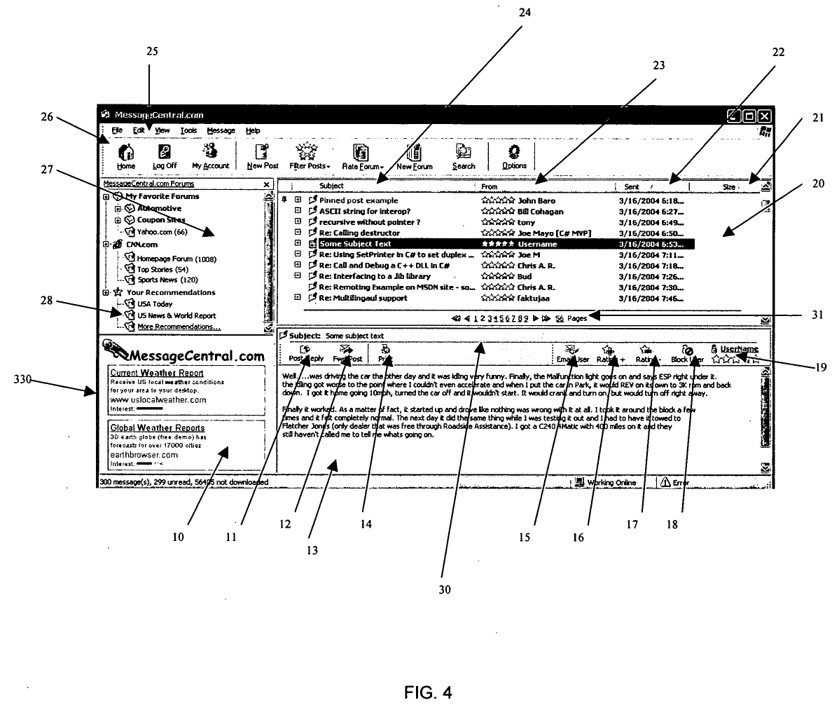

FIG. 4 illustrates an embodiment of the GUI 330. As discussed above, information associated with a particular web site and/or web page may be displayed in the GUI 330. GUI 330 may include Sub-Windows 10, 13, 20, and 27. Sub-Window 10 may display advertisements. Sub-Window 13 may display details of a particular message. Sub-Window 20 may display messages within a particular forum. Sub-Window 27 generally may display the forums for a particular URL.

GUI 330 may include Menus 25, 26, and 30. Menus 25 and 26 may contain selections that are relevant to the entire client software. Menu 30 may include selections that are relevant to the particular message being viewed in Sub-Window 13. Sub-Window 27 may display forums available for a particular URL, favorite forums, and recommended forums or any other information that can be displayed in a hierarchical manner. Sub-Window 20 may display messages within the particular forum selected in Sub-Window 27. The messages in Sub-Window 20 may be listed according to Subject 24, Author Name 23, Creation Date 22, and Size 21. The messages in Sub-Window 20 may be sorted by Subject 24, Author Name 23, Creation Date 22, and Size 21. Selection 31 may allow a large number of messages to be segregated and displayed in groups. Sub-Window 13 may display the message selected in Sub-Window 20 and indicate the message author's Rating 19. The user may respond to the message in Sub-Window 20 by selecting Reply Button 11. Additionally, the user may forward the message in Sub-Window 20 by selecting Forward Button 12. For example, by selecting the Forward Button 12, the user may invoke a conventional email client allowing the user to or may otherwise forward the message to a particular email address. Alternatively, the user may print the message in Sub-Window 20 by selecting Print Button 14. In addition, the user may contact the message author using Email User Button 15. The message author may be evaluated for the quality of the message using Rating Buttons 16 or 17. Finally, the user may block the message author using Block Button 18 so as to prevent all messages from the particular author from being displayed in the GUI 330. Sub-Window 10 may display dynamic or static advertisements.

In an embodiment, the server 230 may obtain forum- and/or category-categorization information over the network 220. A categories hierarchy may be represented thru textual information such as “Top/Arts/Television”. The server 230 may pre-process the data from the original table (Original) and output it to new tables that are organized such that querying the categorization and forum information is optimized. The data is processed from the Original table containing both the detailed information and the hierarchical information for categories and put into two new tables: one containing the detailed information for the categories (CatInfo) and one containing strictly the relationship between categories themselves and categories-forums relationship (CatItems).

The server 230 may extract all the detailed information from the Original table in one pass and put it in the CatInfo table; furthermore a unique identifier is created for each category. In this implementation, the unique identifier is a GUID. On a second pass the server 230 walks thru the categories and processes the hierarchical information for the category. For example, for each token delimited by the ‘/’ character in the following string, “Top/Arts/Television”, one entry will be added to the CatItems table. Each entry consists of the included category identifier in one column and the including category identifier in the other one.

For forums categorization, a similar process is applied where one entry is added for each category that includes the forum.

Table Definitions:

```
        DROP TABLE IF EXISTS ‘directory‘.‘catinfo‘;
        CREATE TABLE ‘catinfo‘ (
    ‘CatGUID‘ varchar(36) NOT NULL default ”,
    ‘CatDisplayName‘ varchar(64) NOT NULL default ”,
    ‘Level‘ tinyint(3) unsigned NOT NULL default ‘0’,
    ‘ParentCatGUID‘ varchar(36) NOT NULL default ”,
    ‘CatID‘ int(10) unsigned NOT NULL default ‘0’,
    ‘CatPath‘ text NOT NULL,
    ‘CatDescr‘ text NOT NULL,
    ‘ChildCount‘ int(10) unsigned NOT NULL default ‘0’,
    PRIMARY KEY (‘CatGUID‘),
    KEY ‘_ixParentCatGUID‘ TYPE BTREE (‘ParentCatGUID‘),
    KEY ‘_ixCatID‘ (‘CatID‘),
    KEY ‘_ix_delme_CatPath‘ (‘CatPath‘(128))
        ) ENGINE=MyISAM DEFAULT CHARSET=utf8;
        DROP TABLE IF EXISTS ‘directory‘.‘catitems‘;
        CREATE TABLE ‘catitems‘ (
    ‘ItemGUID‘ varchar(36) NOT NULL default ”,
    ‘CatGUID‘ varchar(36) NOT NULL default ”,
    ‘ItemType‘ tinyint(3) unsigned NOT NULL default ‘0’ COMMENT
‘1=Forum, 2=Domain’,
    PRIMARY KEY (‘ItemGUID‘,‘CatGUID‘,‘ItemType‘),
    KEY ‘_ixCatGUID‘ (‘CatGUID‘),
    KEY ‘_ixCatGUIDAndItemType‘ (‘CatGUID‘,‘ItemType‘),
    KEY ‘_ixItemGUID‘ (‘ItemGUID‘)
    ) ENGINE=MyISAM DEFAULT CHARSET=utf8;
```

Query Definitions:

```
        SELECT items.catguid, COUNT(1), ci.CatDisplayName FROM catitems
items INNER JOIN
    (catinfo ci INNER JOIN (SELECT items2.catguid FROM catitems items2
WHERE items2.itemguid = “<insert forum GUID here>”) AS tmp
    ON ci.catguid = tmp.catguid) ON items.catGUID = ci.catguid WHERE
items.itemtype = 1 GROUP BY items.catguid ORDER BY ci.level;
        SELECT items.catguid, ci.childcount, ci.CatDisplayName FROM catinfo ci
    LEFT JOIN catitems items ON items.catguid = ci.catguid WHERE items.itemguid =
“<insert category GUID here>” ORDER BY ci.level;
```

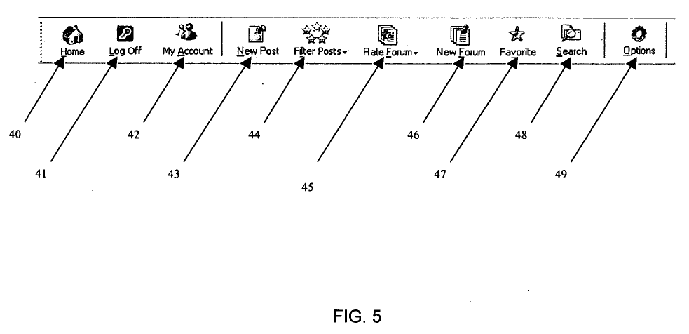

FIG. 5 is an enlarged illustration of an embodiment of the menu 26. The Home Button 40 may direct the parent browser to display content from a particular URL. Login/Logoff Button 41 may enable the user to post content and display content according to user preferences. My Account Button 42 may enable the user to configure account options. New Post Button 43 may enable the user to post a new message to a particular forum. Filter Posts Button 44 may filter and display messages according to the message author's rating. Rate Forum Button 45 may enable the user to rate the current forum. New Forum Button 46 may enable the user to create a new forum for a particular URL. Favorite Button 47 may provide the ability to easily navigate back to the particular forum for future reference. Search Button 48 may enable the user to search messages in all forums or subsets of forums. Options Button 49 may enable the user to configure the client software.

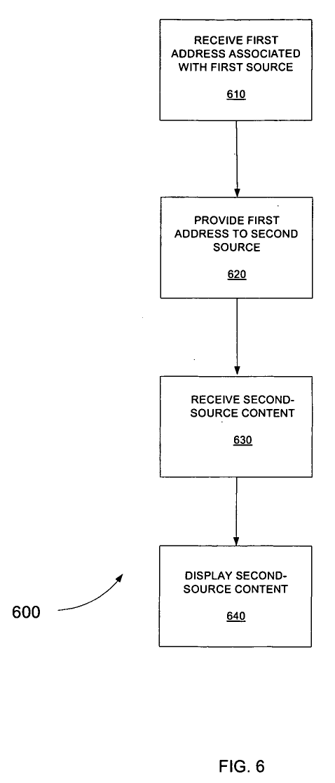

FIG. 6 illustrates a process 600 according to an embodiment of the invention. The process 600 is illustrated as a set of operations shown as discrete blocks. The process 600 may be implemented in any suitable hardware, software, firmware, or combination thereof. The order in which the operations are described is not to be necessarily construed as a limitation.

At a block 610, a first network-address identifier corresponding to first content associated with a first content source is received. For example, the server 260 may function to host a first web site that a user of the client device 210 desires to access. Consequently, the user may point a browser running on the client device 210 to the first web site by entering, for example, a URL, IP address, domain name and/or other identifier associated with the first web site.

At a block 620, the first network-address identifier is provided to a second content source. The second content source may have a second network address different from the first network address. For example, the client application 215 may receive from the browser, and prompt the client device 210 to provide to the server 230, the identifier entered by the user. In an embodiment, the client device 210 may further provide user-authentication information to the server 230.

At a block 630, second content corresponding to the first network-address identifier is received from the second content source. For example, the server 230 may query the database 240 for message-forum information associated in the database with the identifier and/or associated web content. Such associated information present in the database 240 is provided by the server 230 to the client application 215.

At a block 640, the second content is displayed. For example, information provided by the server 230 to the client application 215 may be displayed in, or otherwise used to populate, the GUI 330. In an embodiment, the first and second content may be displayed simultaneously in the same window, or separate respective windows, by the client device 210.

It should be noted that, in an embodiment, the process 600 can be substantially repeated with respect to second and subsequent web sites. For example, a second network-address identifier corresponding to third content associated with a third content source may be received. In this instance, a server (not shown), other than servers 230, 260, may function to host a second web site that a user of the client device 210 desires to access. Consequently, the user may point the browser running on the client device 210 to the second web site by entering, for example, a URL, IP address, domain name and/or other second identifier associated with the second web site.

This second network-address identifier may be provided to the second content source. For example, the client application 215 may prompt the client device 210 to provide to the server 230 the second identifier entered by the user.

Fourth content corresponding to the second network-address identifier may be received from the second content source. For example, the server 230 may query the database 240 for message-forum information associated in the database with the second identifier and/or associated web content. Such associated information present in the database 240 is provided by the server 230 to the client application 215.

The fourth content may then be displayed. For example, information provided by the server 230 to the client application 215 may be displayed in, or otherwise used to populate, the GUI 330.

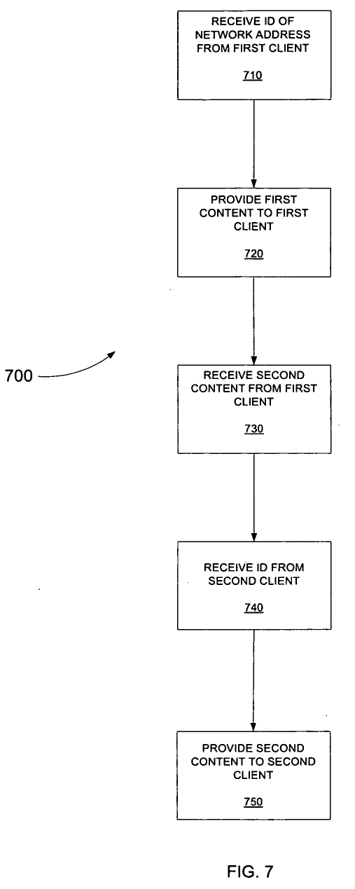

FIG. 7 illustrates a process 700 according to an embodiment of the invention. The process 700 is illustrated as a set of operations shown as discrete blocks. The process 700 may be implemented in any suitable hardware, software, firmware, or combination thereof. The order in which the operations are described is not to be necessarily construed as a limitation.

At a block 710, an identifier of a second network address is received at a first network address from a first client device of a plurality of client devices. For example, the server 260 may function to host a web site that a user of the client device 210 desires to access. Consequently, the user may point a browser running on the client device 210 to the web site by entering, for example, a URL, IP address, domain name and/or other identifier associated with the web site. The client application 215 may then prompt the client device 210 to provide to the server 230 the identifier entered by the user.

At a block 720, in response to receiving the identifier from the first client device, first content corresponding to the second network address is provided to the first client device. For example, the server 230 may query the database 240 for message-forum information associated in the database with the identifier and/or associated web content. Information present in the database 240 is provided by the server 230 to the client application 215. This information may include user-interface elements (e.g., selectable hyperlinks, data-entry fields, etc.) enabling the user to interact with the client device 210 and/or server 230. Moreover, at least a portion of this information may have been received by the server 230 from the client device 210, 250 or other client device.

At a block 730, second content from the first client device is received at the first network address. For example, the client application 215 may enable the user of the client device 210 to post to the server 230 comments or other content that may, but need not, pertain to the web site. The server 230 may store the posted content in the database 240 in such manner as to associate the posted content with the identifier and/or associated web content.

At a block 740, the identifier is received at the first network address from a second client device of the plurality of client devices. For example, a user may point a browser running on the client device 250 to the web site hosted by the server 260 by entering the identifier associated with the web site. The client device 250 may then provide to the server 230 the identifier entered by the user.

At a block 750, in response to receiving the identifier from the second client device, the second content is provided to the second client device. For example, the server 230 may query the database 240 for message-forum information associated in the database with the identifier and/or associated web content. Such associated information present in the database 240, including the content posted by the user of the client device 210, is provided by the server 230 to the client device 250. This information may include user-interface elements (e.g., selectable hyperlinks, data-entry fields, etc.) enabling the user to interact with the client device 250 and/or server 230.

While the preferred embodiment of the invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A computer-readable medium having computer-executable instructions for performing steps comprising:
receiving an identifier of a first network address corresponding to first content associated with a first content source;
providing the first network-address identifier to a second content source;
receiving from the second content source second content corresponding to the first network-address identifier; and
displaying the second content.

2. The medium of claim 1 having further instructions for performing the step of simultaneously displaying the first content and the second content.

3. The medium of claim 2 having further instructions for performing the step of displaying the first content and the second content in a first display window.

4. The medium of claim 2 having further instructions for performing the step of displaying the first content in a first display window and the second content in a second display window.

5. The medium of claim 1 having further instructions for performing the steps of:
receiving a second network-address identifier corresponding to third content associated with a third content source;
providing the second network-address identifier to the second content source;
receiving from the second content source fourth content corresponding to the second network-address identifier; and
displaying the fourth content.

6. The medium of claim 1 having further instructions for performing the step of providing user-authentication information to the second content source.

7. The medium of claim 1 wherein the first network-address identifier is received from a browser application operable to access the first content.

8. The medium of claim 1 wherein the second content comprises a message forum.

9. The medium of claim 1 wherein the second content source has a second network address different from the first network address.

10. A system, comprising:
(a) a memory device; and
(b) a first electronic device having a first network address and coupled to the memory device and a plurality of client devices, the first electronic device operable to:
(i) receive from a first client device of the plurality an identifier of a second network address;
(ii) retrieve from the memory device first content corresponding to the second-network-address identifier; and
(iii) provide the first content to the first client device.

11. The system of claim 10 wherein the memory device comprises a database.

12. The system of claim 10 wherein the first electronic device is further operable to:
receive from the first client device an identifier of a third network address;
retrieve from the memory device second content corresponding to the third-network-address identifier; and
provide the second content to the first client device.

13. The system of claim 10 wherein the first electronic device is further operable to:
receive from a second client device of the plurality the second-network-address identifier;
retrieve from the memory device the first content; and
provide the first content to the second client device.

14. The system of claim 13 wherein the first electronic device is operable to receive second content from the first client device.

15. The system of claim 14 wherein the first electronic device is operable to provide the second content to the second client device.

16. A method, comprising:
receiving, at a first network address and from a first client device of a plurality of client devices, an identifier of a second network address;
providing to the first client device, in response to receiving the identifier from the first client device, first content corresponding to the second network address;
receiving, at the first network address, second content from the first client device;
receiving, at the first network address and from a second client device of the plurality of client devices, the identifier; and
providing to the second client device, in response to receiving the identifier from the second client device, the second content.

17. The method of claim 16 wherein providing the first content comprises providing a user interface including the first content.

18. The method of claim 16 wherein providing the second content comprises providing a user interface including the second content.

19. The method of claim 16, further comprising receiving the first content from a client device of the plurality.

20. The method of claim 19, further comprising associating in a memory the first content with the second network address.
